(19) United States
(12) Patent Application Publication
(10) Pub. No.: US 2001/0032862 A1
(43) Pub. Date: Oct. 25, 2001

(54) Grout sealant applicator

(76) Inventor: Floretta Beth Yenglin, Las Vegas, NV (US)

Correspondence Address: Floretta Yenglin, 9904 Dusty Winds Ave., Las Vegas, NV, 89117, US

(21) Appl. No.: 09/773,746

(22) Filed: Feb. 2, 2001

Related U.S. Application Data
(60) Provisional application No. 60/146,982, filed on Aug. 3, 1999.

(51) Int. Cl. B67D 5/38; B65D 25/40; B65D 35/38

(52) U.S. Cl. 222/23; 222/158; 222/215; 222/568

(57) ABSTRACT

A tool designed to efficiently apply sealant to tile grout can be described as a plastic, main bottle (4), round in design with ounce indicator lines marked on the exterior (8); and a plastic nozzle (10) that tightly screws onto the bottle, via embedded threads inside the top of the bottle (16) and inside the base of the nozzle (18). Main cellulose sponge material (6) is fitted tightly inside the bottle (4) and secondary sponge material (12) is fitted tightly inside the nozzle (10); which controls the amount of sealant flow so that there is minimal dripping or waste of sealant. The applicator holds approximately 6 ounces of liquid grout sealant. The tip of the nozzle is marked (14) so it can be cut with a razor to match the flow of sealant to the width of the grout. The application of sealant is accomplished by gently applying pressure to the flexible bottle (4) and moving the tip at a 45 degree angle along the line of grout to be sealed, releasing the sealant all along the way.

### BACKGROUND—FIELD OF INVENTION

A Grout Sealant Applicator relates to a significantly improved method of applying sealant to tile grout.

### BACKGROUND—DESCRIPTION OF PRIOR ART

Applicators presently designed to apply grout sealant are grossly inferior. However, some are still presently on the market. Flow of sealant is excessive with these devises, involving wastage of sealant. Also, application of sealant is considerably less than precise, also involving wastage of sealant. Therefore, with other tools, the average time necessary to complete a typical grout sealing job (600 square feet) is approximately three times greater. This involves extra time for cleanup, requiring the use of multiple rags. Also, costs of manufacturing most prior grout sealant applicators is higher.

The following is a list of the four grout sealant applicators that could now be found on the market:

The Silicone Grout Sealer has the problem of a nozzle that is much too wide to accommodate the various sizes of grout. It also gives such a thin layer sealant that grout separate needs to be applied several times, requiring more time to complete a grout sealant job.

Ez Seal holds a very small amount of sealant and so requiring excessive refills. Flow of sealant is controlled by the level of the brush nozzle which requires repeated adjusting. Also, this nozzle wears out quickly, requiring the purchase of additional tools to complete a 600 sf applicator job.

The Rollar Boy is comprised of hard, plastic wheels that do not absorb sealant. Therefore, you can only seal 1 ″ at a time before getting more sealant. This results in much dripping and, therefore, waist of sealant.

The foam Sponge Brush holds so little sealant that an excessive amount of time is spent moving from the sealant container to the grout, causing dripping and waist of sealant. Also, there is waist of sealant and excessive cleanup due to the sponge overlapping onto the tile. Finally, this applicator wears out quickly, requiring a minimum of 5 sponge brushes to complete a 600 sf grout applicator job.

All four of the above applicators require considerably more time to complete a typical grout sealing job (600 sf.).

Prior art often includes applicator bottles that are designed to dispense material other than grout sealant. One bottle dispenses powder, U.S. Pat. No. 4,730,751 by Mackles et al.(1988). Others dispense foam, U.S. Pat. No. 3,010,613 by Stossel (1961), U.S. Pat. No. 3,308,993 by V. M. Bruno (1967), U.S. Pat. No. 3,985,271 by Gardner (1976), and U.S. Pat. No. 4,027,789 by Dickey (1977). Such devices are therefore not appropriate to sealing grout with liquid. Two prior liquid dispensing devices are inferior in that they are uncomfortably complex; U.S. Pat. No. 6,021,930 by de Pous et al. (2000) and U.S. Pat. No. 3,189,223 by Mackal (1965)—and so not efficient. Finally, a tip of a solution dispenser, U.S. Pat. No. 5611,464 by Tsau et al. (1997) is a grossly incomplete device. Such tools are, therefore, not competitive in applying grout sealant to grout.

A professional patent search reveals there is no prior art that is comparably efficient to the Grout Sealant Applicator in applying sealant to grout. Enclosed is a copy of the results of this search.

### SUMMARY

The remarkably simple Grout Sealant Applicator is specifically designed to apply grout sealant to tile grout. With this applicator, the job is done in a manner that is efficient in amount of time and money required to complete the sealing of applicator to grout. The applicator does so with the use of a main bottle with a nozzle attached, both containing sponge material. When the nozzle is cut the width of the grout, the sealant can be easily applied by squeezing the bottle, releasing sealant along the lines of grout.

### Objects and Advantages

Accordingly, several objects and advantages of the Grout Sealant Applicator are:

(a) It provides an approximate 66% reduction in application time.

(b) It provides an approximate 75% reduction in necessary grout sealant.

(c) It is a device simple enough to quickly learn to use.

(d) It is a device precise enough to be able to apply sealant to various widths of grout.

(e) It involves very little waste of grout sealant.

(f) Hands do not touch sealant thereby reducing problems for those with allergies.

(g) It is inexpensive enough a device to be able to discard after use.

(h) It is designed to accommodate the wide variety of sealants on the market.

(i) It is flexible enough in design to allow variation in the color of the exterior.

Prior art is most often too complex and so too expensive to produce or sell at a price competitive with the Grout Sealant Applicator. In addition, it simply does not apply sealant to grout in an efficient manner.

Further objects and advantages of the applicator will become apparent from a consideration of the drawings and ensuring description.

### DRAWING FIGURES

FIG. 1 and FIG. 2 show various parts of the Grout Sealant Applicator.

### Reference Numerals in Drawings

4 main bottle

6 main fitted, cellulose sponge material

8 indicator lines on side of applicator bottle

10 nozzle

12 secondary fitted, cellulose sponge material

14 indicator lines on side of nozzle

16 embedded threads inside top of bottle

18 embedded threads inside base of nozzle

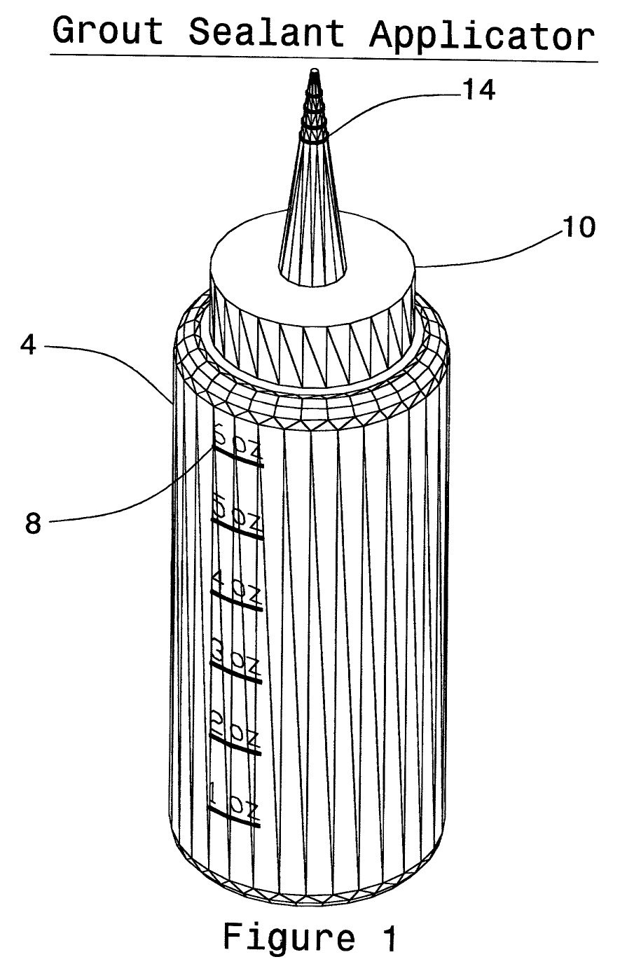

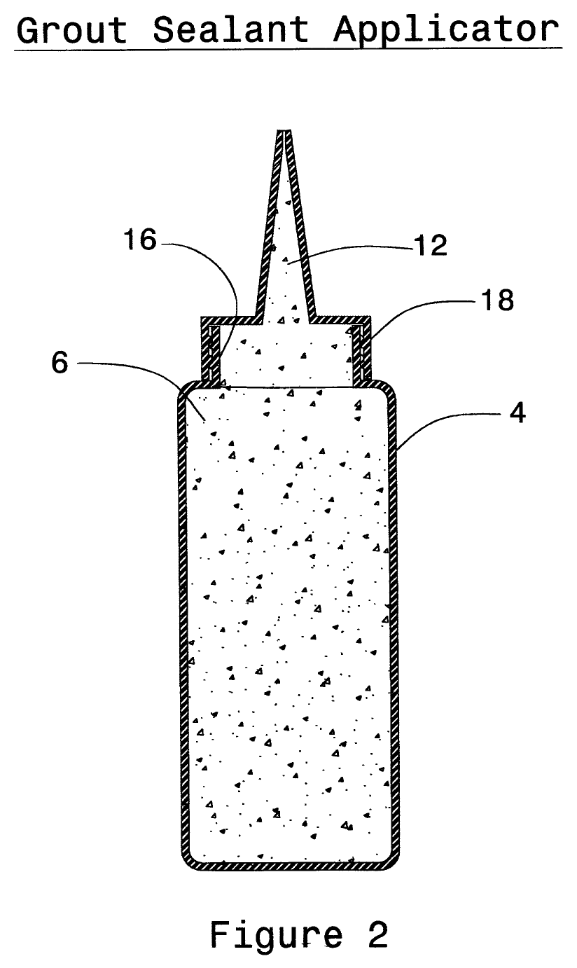

### DESCRIPTION—FIG 1 and FIG. 2—Preferred Embodiment

A preferred embodiment of the applicator is illustrated in FIG. 1 (exterior//front view) and FIG. 2 (interior/front view). The main body of the applicator consists of the bottle 4; round in design, and composed of flexible, plastic material. The bottle has embedded threads 16, in the inside top to allow a nozzle to screw on. Main fitted, cellulose sponge material 6 is located inside the applicator bottle 4. Indicator lines on the side of the applicator bottle 8 indicate the number of ounces of sealant in the bottle 4. The nozzle 10 is made of rigid plastic with embedded threads at its base 18 so that it screws onto the applicator bottle. Secondary fitted, cellulose sponge material 12 is located in the nozzle. Indicator lines on the side of the nozzle 14 can be cut so the nozzle matches the width of the grout.

the Grout Sealant Applicator typically consists of the following measurements:

The main bottle is 12.50 mm tall and 5 mm in diameter at the base.

The nozzle is 5.62 mm tall and 4.08 in diameter at the base.

The entire tool (main bottle plus nozzle) is 16.88 mm tall.

### Advantages

From the description above, a number of advantages of the Grout Sealant Applicator becomes evident:

(a) The sponge material, fitted inside the plastic body and the nozzle of the applicator creates an appropriate flow of sealant and minimizes any waste of sealant.

(b) The plastic nozzle can be cut to create a minimum flow of sealant that is custom designed to fit the width of grout.

(c) The applicator is so inexpensive to manufacture that even at a low sales price, it is extremely cost effective. Therefore, it can also be comfortably disposed of after a grout sealing job is complete.

(d) The applicator enables a grout sealant job to be completed in less time and expense than does any other tool available.

(f) Even an unsteady and/or unskilled hand can successfully seal grout with this applicator since it is so easy to learn and use.

### Operation—FIG. 1

The process of using the Grout Sealant Operator shown in FIG. 1 involves 9 basic steps in the order presented below:

1) Unscrew the nozzle 10 from the main, applicator bottle 4 where the embedded threads inside the base of the nozzle 18 screw on to the embedded threads at the top of the bottle 16.

2) Fill the bottle 4 with your choice of grout sealant to the 6th, indicator line 8.

3) Again, tightly screw the nozzle 10 onto the bottle 4.

4) Determine the indicator line at the top of the nozzle 14 that best fits the g width. Cut off the nozzle 10 tip to the chosen line 14 with a razorblade.

5) Place the bottle 4 at about a 45 degree angle and gently lay the tip of the nozzle 10 on the grout.

6) Gently apply pressure to the bottle 4 and move the bottle 4 along the line of the grout, releasing sealant all along the way.

7) Refill the bottle 4 as needed.

8) Make as many applications as the sealant manufacturer requires.

9) When the job is completed you can easily discard the inexpensive Grout Sealant Applicator if you choose.

### Conclusion, Ramifications, and Scope

Accordingly, the reader will see that the Grout Sealant Applicator can be used to seal grout easily and conveniently. Also, when a sealant job is complete, the applicator is so inexpensive it can be discarded (however, it can be used again if desired). Furthermore, the Grout Sealant Applicator provides the following additional advantages:

It can be manufactured in a larger size to accommodate more sealant and require fewer refills.

It can be made a different color,

Directions for usage can be simple and brief since the applicator is so simple to use.

I claim:

1. A grout sealant applicator designed to apply sealant to tile grout comprising:
(a) a main bottle
(b) a nozzle
(c) a sponge material
(d) means for indicating ounces of sealant inside of said bottle
(e) means for adjusting said nozzle to fit width of grout to be sealed.
(f) means for tightly joining said bottle to said nozzle.

2. The applicator of claim 1, wherein said main bottle is made of a flexible plastic.

3. The applicator of claim 1 where said main bottle is opaque.

4. The applicator of claim 1 wherein said sponge material is snugly fitted inside said main bottle.

5. The applicator of claim 4 wherein said sponge material is cellulose.

6. The applicator of claim 1 wherein said main bottle includes clearly visible indicator lines on the side showing ounces.

7. The applicator of claim 1 wherein said main bottle is round in structure.

8. The applicator of claim 1 wherein said main bottle has a predetermined height.

9. The applicator of claim 1 wherein said main bottle is colored.

10. The applicator of claim 1 wherein said nozzle is made of rigid plastic.

11. The applicator of claim 1 wherein said sponge material is snugly fitted inside nozzle.

12. The applicator of claim 11 wherein said sponge material is cellulose.

13. The applicator of claim 1 wherein said nozzle includes clearly visible indicator lines that can be cut to match various grout width.

14. The applicator of claim 1 wherein said nozzle has a predetermined height.

15. The applicator of claim 1 wherein said nozzle is colored.

16. The applicator of claim 1 wherein said main body has embedded threads inside the top that match threads embedded inside the base of said nozzle; so that said main bottle can screw tightly onto said nozzle.
whereby a grout sealant application job can be completed more quickly and economially than is now the case with other grout sealant applicators presently available.
